(19) United States
(12) Patent Application Publication
(10) Pub. No.: US 2020/0315144 A1
(43) Pub. Date: Oct. 8, 2020

(54) A reservoir tail reverse regulation method for native fish protection

(71) Applicant: Yunnan University, Kunming, Yunnan (CN)

(72) Inventors: Daming He, Kunming, Yunnan (CN); Ying Lu, Kunming, Yunnan (CN); Hailong Wang, Kunming, Yunnan (CN); Feng Pan, Kunming, Yunnan (CN); Hui Fan, Kunming, Yunnan (CN); Yulong Liu, Kunming, Yunnan (CN)

(21) Appl. No.: 16/300,584

(22) PCT Filed: Apr. 25, 2018
(86) PCT No.: PCT/CN2018/084315

§ 371 Date: Nov. 12, 2018

(30) Foreign Application Priority Data
Jun. 5, 2017 (CN) 201710414679.2

(51) Int. Cl. A01K 61/10; E02B 8/00

(52) U.S. Cl. CPC A01K 61/10; E02B 8/00

(57) ABSTRACT

The invention discloses a reservoir tail reverse regulation method for native fish protection, comprising the steps that firstly, a breeding habitat of native fishes at reservoir tail of a cascade hydroelectric dam is determined; secondly, breeding characteristics of migration native fishes are determined, and an ecological conservation project of a reach of the breeding habitat at reservoir tail is carried out; thirdly, the length of the reservoir tail of a downstream hydropower station of a cascade hydroelectric project in March to May is determined through a field investigation, and the maximum range of a natural river channel downstream of the upstream cascade power station is judged and finally, the flow state of the reach at reservoir tail is reversely regulated to achieve the goal of discharging water of the natural river channel at the reservoir tail and ensuring the natural flow state of the natural river channel.

### FIELD OF THE INVENTION

The invention relates to the field of environmental hydraulic engineering and the field of ecological environmental protection, in particular to a reservoir tail reverse regulation method for native fish protection.

### BACKGROUND ART

As a clean energy, hydropower is one of the key directions for future energy development, in the proposal, the total installed capacity of hydropower in China will reach 420 million kilowatts by 2020. In order to achieve this goal, hydropower cascade development has been intensively carried out in major river basins in southwestern China. However, hydropower cascade development has led to dramatic changes in the living environment of native fishes in original river, and there is a huge contradiction between energy development and environmental protection. The hydroelectric dams blocked the river and directly changed the hydrological regimes such as water level, flow state, sediment charge, water temperature, etc. and riverbed formation of the original river, especially for the construction of cascade hydropower, its development characteristic is to “efficient exhausted” the potential energy of every inch of water head; between adjacent power stations, the original natural river system is turned into a “river-reservoir” system when the hydrostatic reach of reservoir tail in lower stage reservoir reaches under the dam of upper stage reservoir, which dramatically changed the fluvial morphology and the flux of biogenic elements. Native fishes, which originally adapted to the fluvial morphology and had migratory characteristics, have undergone a deteriorating state of living due to the great changes in the living environment and the competition from exotic stagnicolous fish.

How to protect native fish germplasm resources under the situation that cascade hydropower development has been widely concerned by all parties including hydropower developers. The prior native fish protection measures mainly include: fishing passing dams with net, propagation and releasing, and fish ladder fishway construction, but they cannot fundamentally solve problems of fish population degradation and the disappearance of breeding grounds caused by changes in habitat environment. Therefore, focusing on the breeding characteristics of native fishes, studying how to restore fish breeding and feeding grounds featured with natural rivers, to plan to establish fish conservation habitats, to promote the construction of environmentally friendly cascade hydropower stations in ecological barrier zone southwestern China and green hydropower energy base, and to preserve precious fish germplasm resources for future generations, all have become major technological demands for the national, local and power groups, and practical problems that need to be solved urgently. In addition, the prior regulation technologies have the following defects: 1. The problem of fish species diversity protection in mountain rivers cannot be solved; 2. The prior regulation technologies, especially the fish ladder fishway construction, have extremely poor effects on dams with dam heights exceeding 30 meters. Most dams on mainstream of rivers in southwestern mountainous area are more than 100 meters high, reservoirs with 200-300 meters high dams are common; 3. The regulation of the hydrodynamic conditions (flow states of the torrent, dangerous shoals and backwaters) that meet the migration, spawning and breeding requirements of fishes is a worldwide problem.

### SUMMARY OF THE INVENTION

Due to the facts that constructions of prior cascade hydroelectric dams have resulted in a dramatic impact on the habitat of native fishes and the breeding habitat has disappeared, the invention aims to solve a technical problem to providing a reservoir tail reverse regulation method for native fish protection, based on this method, the hydropower regime of the reservoir tail reach can be met the hydrological conditions required for the breeding period of the native fishes and the breeding habitat can be reproduced to achieve the purpose of preserving native fish germplasm resources.

The invention provides a technical scheme: a reservoir tail reverse regulation method for native fish protection, comprising following steps:

Step 1, a breeding habitat of native fishes at the reservoir tail of a cascade hydroelectric dam is determined;

Step 2, the breeding characteristics of the migration native fishes are determined, and an ecological conservation project of a reach of the breeding habitat at the reservoir tail is carried out;

Step 3, reservoir tail reverse regulation method of the cascade hydroelectric dam, the length of the reservoir tail of a downstream hydropower station of a cascade hydroelectric project in March to May is determined through a field investigation, and the maximum range of a natural river channel downstream of an upstream cascade power station is judged, that is reverse regulation reach; in order to ensure the reservoir tail of the power station, that is, the hydrological regime at breeding habitat reach of native fishes meets the requirements for fish breeding and spawning, an elevation measurement of reservoir area river bed, calculations of cascade hydropower storage capacity, water level and discharge flow are carried out; according to the calculation results, the discharge flow of a upstream hydroelectric dam and a downstream hydroelectric dam are jointly scheduled, and finally a flow state of the reach at the reservoir tail is reversely regulated to achieve the goal of discharging water of the natural river channel at the reservoir tail and ensuring the natural flow state of the natural river channel.

Further, in Step 1, the breeding habitat of native fishes is disposed at a reach of the cascade hydroelectric project, between two hydropower stations and under upstream hydroelectric dam, that is, reservoir tail of the downstream hydroelectric dam; from March to May, the field investigation of reservoir tail area and data collection of hydrological regime are carried out, combined with fluvial morphology, landform, river flow, water level, flow rate, sediment charge and sediment quality, a reach which is distinct from the water characteristics of the lake and has natural river characteristics is further selected as a reverse regulation reach.

Further, the Step 2 comprises, through field investigation and data analysis, identifying species of to-be-protected native fishes and seeking surviving and breeding characteristics thereof including population quantity and structure, spawning time and water temperature, flow rate, water transparency, and sediment charge required by the breeding ground; according to the breeding characteristics of native fishes, the artificial fish breeding ecological restoration measures are arranged in the native fish breeding habitat determined in Step 1, including artificially excavating shallow channel and deep pool of the river, constructing shore protection and slope vegetation, arranging fish nest and river branch remediation and carrying out artificial propagation and releasing of important native fishes in the habitat.

Further, in Step 3, the regulation process is based on the realization of the upstream hydroelectric dam simulating natural river flow state and the downstream hydroelectric dam controlling the realization of the goal that discharging water of the natural river channel at the reservoir tail, the discharge flow of the upstream hydroelectric dam and the downstream hydroelectric dam is obtained by the following methods:

A calculation method of the discharge flow of the upstream hydroelectric dam:

Taking the dekad water inflow process at the breeding and spawning reach from March to May during dry years, as the minimum water requirement for the reach to ensure the normal breeding and spawning of fishes; taking the dekad water inflow process from March to May during wet years as the maximum water requirement for the reach to ensure the normal breeding and spawning of fishes;

Wherein the dekad water inflow process from March to May during dry years is obtained by the following method: collecting measured daily flow data from March to March at the fish spawning reach, the data sequence length n must be greater than 30 years; yearly counting the total water inflows Wᵢ (i=1, 2, . . . , n) from March to May, and calculating hydrologic frequency analysis of total water inflows Wᵢ from March to May by the Pearson III curve; the probability density function is:

$$f ( x ) = \frac{{β}^{α}}{Γ ( α )} {( x - {α}_{0} )}^{α - 1} {e}^{- β ( x - {α}_{0} )}$$

Wherein, Γ(α) is the gamma function of α; α, β and α₀ are respectively the shape, scale and positional parameters of the Pearson III distribution, α>0, β>0, taking the corresponding water inflows WS_{dry} when the water inflows guarantee rate P=90% (P is the design guarantee rate, that is, in the long term, the water inflows in 90% of the years are greater than or equal to the WS_{dry}); for the water inflows of basin section is directly proportional to the basin area and average precipitation thereof, the calculation of water inflows from the fish spawning ground is calculated according to formula (1);

$${WF}_{dry} = {WS}_{dry} \times \frac{AF}{A S} \times \frac{PF}{P S} \qquad ( 1 )$$

wherein, WF_{dry} is a design water inflows from March to May during dry years in the fish spawning ground; WS_{dry} is a design water inflows from March to May during dry years in reference hydrological station; AF and AS are basin areas above the fish spawning ground and above reference hydrological station respectively; PF and PS are annual mean precipitation of basins above the fish spawning ground and above reference hydrological station respectively;

according to the measured daily flow data, annual dekad flow process from March to May is counted; according to the principle that the total water inflows are similar and are conducive to breeding and spawning of fishes, a typical process of dekad distribution of water inflows from March to March is selected from the data sequence, according to the typical process and the determined total water inflows WF_{dry} from March to May, the water inflows process under the design guarantee rate P=90% is obtained by formula (2), as the lowest target process of upstream reservoir ecological regulation;

q_{dryij}=WF_{dry}·Qᵢⱼ/Σₖ₌₃⁵Σₗ₌₁³Qₖₗ (2)

Wherein, q_{dryij} is the lowest target ecological regulation flow of upstream reservoir in the jth ten days of the i month; WF_{dry} is the water flows when the design guarantee rate of fish spawning reach P=90%;

the dekad water inflow process q_{wetij} from March to May during wet years can be determined in the same way;

An ecological regulation flow QEᵢⱼ of upstream reservoir in the jth ten days of the i month is determined by formula (3), there is no need to increase the ecological regulation flow when power generation flow QPᵢⱼ of the upstream reservoir is greater than or equal to the target ecological regulation flow q_{dryij}, and less than or equal to q_{wetij}; it is necessary to increase the ecological regulation flow through the reservoir ecological regulation when the power generation flow QPᵢⱼ of the upstream reservoir is less than the target ecological regulation flow q_{dryij};

During the ecological regulation period of the reservoir from March to May, the ten-days average discharge flow of the reservoir should not exceed the flow of the same period in wet years;

$$Q {E}_{ij} = \{ \begin{matrix}0 , {q}_{wetij} \geq Q {P}_{ij} \geq {q}_{dryij} \\ {q}_{ij} - Q {P}_{ij} , {QP}_{ij} < {q}_{ij}\end{matrix} \qquad ( 3 )$$

wherein, QEᵢⱼ is the ecological regulation flow of upstream reservoir in the jth ten days of the i month; QPᵢⱼ is the power generation flow of the upstream reservoir in the jth ten days of the i month;

(2) A calculation method of the discharge flow of the downstream hydroelectric dam:

The discharge flow of the downstream hydroelectric dam is regulated according to the water level, that is, during the breeding and spawning period of native fishes from March to May, a water level in the hydrostatic reservoir area of the downstream dam is regulated to not higher than the water level elevation at the end of the reservoir tail reach.

Advantageous effects of the invention: compared to the prior art, the invention, based on advantages of native fish breeding characteristics and discharging water of the natural river channel at the reservoir for flood control needs, using the joint regulation capability of the cascade hydropower, combining techniques of ecological restoration and fish conservation projects, provides a reservoir tail reverse regulation method for native fish protection. Under the conditions of no need to demolish dams and to implement large-scale infrastructure projects, the method can meet the needs of cascade hydropower aquatic ecosystem protection and sustainable development of river basins, fill and improve the theory and technical system of river fish habitat protection, and provide simple and easy remedial measures and operational ideas for the ecological restoration of the cascade hydropower projects. The prior cascade hydroelectric dams that have been built have not been built with fish facilities (fish ladders, fishway, etc.) due to terrain, technology and investment conditions. Even if the fish facilities are arranged for a few fish species, there are drawbacks such as large investment, ineffective effect and difficult maintenance. The breeding period of most fishes is from March to May per year, the reservoir tail reverse regulation method for native fish protection of the invention is based on a theoretical basis that to realize the original habitat reproduction in native fish breeding period, and the invention, treating native fish species in the reservoir area with no difference, combining appropriate habitat conservation measures which improves the success rate of native fish upstream breeding, can realize the protection of wild germplasm resources. The hydropower stations need to lower the water level every year from March to May for flood control needs, therefore, the implement of the reservoir tail reverse regulation method does not require additional economic and maintenance costs. Compared with the rebuilding fish facilities after building cascade hydropower construction, the reservoir tail reverse regulation method is more acceptable and implemented by the hydropower group.

### DESCRIPTION OF THE DRAWINGS

In order to more clearly illustrate the embodiments of the invention or the technical schemes in the prior art, the drawings of the embodiments or the prior art will be briefly described below, obviously, drawings in the following description are merely some of the embodiments of the invention, and those skilled in the art can obtain other drawings based on these drawings without any creative work.

FIG. 1 is a schematic diagram showing the overall arrangement of the reservoir tail reverse regulation method of the invention.

FIG. 2 is a schematic diagram showing the water level of the cascade reservoir before reverse regulation.

FIG. 3 is a schematic diagram showing the water level of the cascade reservoir after reverse regulation.

FIG. 4 is a schematic diagram of an embodiment of the invention.

In drawings, 1 refers to upstream hydroelectric dam, 2 refers to downstream hydroelectric dam, 3 refers to reverse regulation reach and 4 refers to the water level in the hydrostatic reservoir area of the downstream dam.

### DESCRIPTION OF THE PREFERRED EMBODIMENTS

The technical schemes in the embodiments of the invention will be further described in detail below with reference to the accompanying drawings, obviously, the described embodiments are merely a part of the embodiments of the invention, and not all of the embodiments. All other embodiments obtained by those skilled in the art based on the embodiments of the invention without creative efforts are within the scope of the invention.

A reservoir tail reverse regulation method for native fish protection, comprising determination of a breeding habitat and breeding characteristics of the native fishes at the downstream reach of a cascade hydroelectric dam, conservation projects for fish habitats, and reverse regulation of upstream cascade power station. The technical principle is that the cascade hydroelectric stations reduce the storage capacity for flood control needs from March to May every year, and the reservoir tail lake-type river channel is turned into a natural runoff type river, wherein the time coincides with the upstream breeding period of native fishes; simultaneously, by manually regulating the discharge flow of adjacent cascade hydropower stations to make the hydrological regime of reservoir tail reach close to that of nature, accompanying ecological restoration measures such as artificial fish nest and artificial flood peak, suitable fish breeding habitats are built, thereby the purpose of preserving native fish germplasm resources can be achieved.

The determination of breeding habitat of the native fishes at the downstream reach of a cascade hydroelectric dam, refers to, through a field investigation, identifying the reach which has natural river characteristics in fluvial morphology (comprising torrent area, slack water area, deep channel area and shoal water area) and hydrological characteristics (no significant stratification of water temperature and rich sediment quality of riverbed), and is significantly distinct from the hydrostatic reach in reservoir.

The determination of breeding characteristics of the native fishes, refers to, through reviewing technical documents, conducting investigations and reports on river historical fish stocks (including but not limited to ichthyography and hydropower development environmental impact reports) and carrying out field investigation, identifying native fish species and life history characteristics thereof; including breeding period, mating and breeding water layer, flow rate and water temperature suitable for breeding, materials of fish egg attachment and water temperature suitable for fish egg incubation, etc.

Conservation projects for fish habitats, refer to ecological measures, water environmental measures, conservation measures and evaluation measures. Wherein, the ecological measures comprise ecological slope protection and bank protection and ecological restoration of shore protection; the water environmental measures comprise water quality protection of fish habitats (ensure that the water quality meet requirements for fish surviving and breeding), water pollution control, etc.; the conservation measures comprise artificial propagation and releasing, artificial arrangement of fish nest, artificial shoal works and measures against fishing during breeding period, etc.; the evaluation measures comprise monitoring of species and quantity of native fish resources, monitoring of water environment and ecosystem in habitat, etc.

The reverse regulation of upstream cascade power station, refers to ensuring that the downstream dam reach presents a natural fluvial morphology during the period from March to May each year through regulating the discharge flow of adjacent cascade hydropower stations. Especially through joint scheduling, the downstream power station reversely regulates the water level at the reservoir tail. The technical process comprises elevation measurement of reservoir area river bed, calculations of flood control water level, storage capacity and discharge flow, etc., combining with the migratory breeding characteristics and protection requirements of fish in the reach, targeted controlling the discharge flow, thereby the water level, flow and hydrological regime can be controlled.

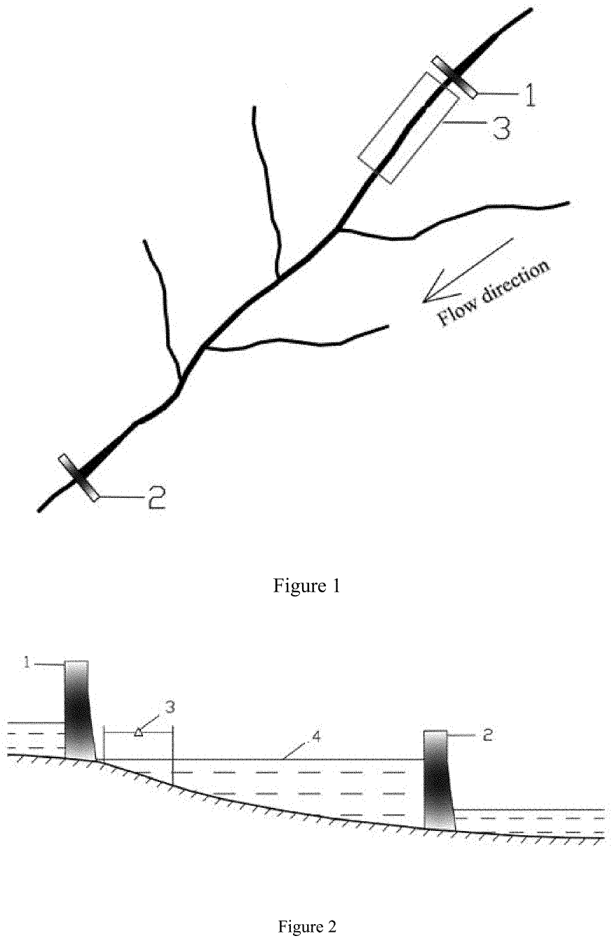

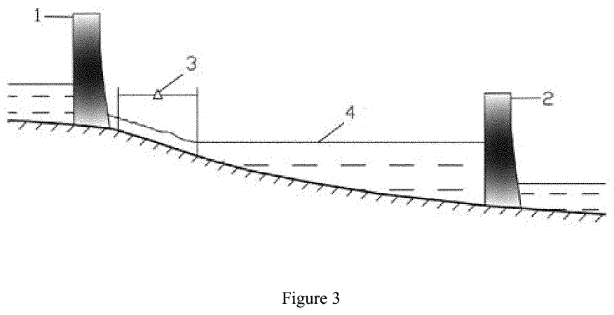

As shown in FIGS. 1 to 3, determining a breeding habitat reach of migration native fishes at the reservoir tail of a cascade hydroelectric dam, arranging ecological conservation projects of a determined reach of the breeding habitat at the reservoir tail, using the joint regulation capability of the cascade hydropower to regulate the hydroogical regime such as flow, water level at the reservoir tail of dam, restoring natural river system and promoting population breeding of fishes, thereby the purpose of preserving native fish germplasm resources can be achieved, the implementation steps are as follows:

Step 1, determining a breeding habitat of native fishes at the reservoir tail of a cascade hydroelectric dam, comprising: the breeding habitat of native fishes is disposed at a reach of the cascade hydroelectric project, between two hydropower stations and under upstream hydroelectric dam 1, that is, reservoir tail of the downstream hydroelectric dam 2; from March to May, the field investigation of reservoir tail area and data collection of hydrological regime are carried out, combined with fluvial morphology, landform, river flow, water level, flow rate, sediment charge and sediment quality, a reach which is distinct from the water characteristics of the lake and has natural river characteristics is further selected as a reverse regulation reach 3.

Step 2, determining breeding characteristics of the migration native fishes, and carrying out an ecological conservation project of a reach of the breeding habitat at the reservoir tail, comprising: through field investigation and data analysis, identifying species of to-be-protected native fishes and seeking surviving and breeding characteristics thereof including population quantity and structure, spawning time and water temperature, flow rate, water transparency, and sediment charge required by the breeding ground; according to the breeding characteristics of native fishes, the artificial fish breeding ecological restoration measures are arranged in the native fish breeding habitat determined in last step, including artificially excavating shallow channel and deep pool of the river, constructing shore protection and slope vegetation, arranging fish nest and river branch remediation, and preferably, carrying out artificial propagation and releasing of important native fishes in the habitat.

Step 3, reservoir tail reverse regulation method of the cascade hydroelectric dam, comprising: the length of the reservoir tail of a downstream hydropower station of a cascade hydroelectric project in March to May is determined through a field investigation, and the maximum range of a natural river channel downstream of an upstream cascade power station is judged, that is reverse regulation reach 3; in order to ensure the reservoir tail of the power station, that is, the hydrological regime at breeding habitat reach of native fishes meets the requirements for fish breeding and spawning, calculations of cascade hydropower storage capacity, water level and discharge flow are carried out; according to the calculation results, the discharge flow of a upstream hydroelectric dam 1 and a downstream hydroelectric dam 2 are jointly scheduled, especially the discharge flow of a downstream hydroelectric dam 2, and finally a flow state of the reach at the reservoir tail is reversely regulated.

In the regulation of cascade hydropower, data such as water inflows, characteristics, power generation load and conventional scheduling in the reservoir area, and reverse regulation is carried out to achieve the goal of discharging water of the natural river channel at the reservoir tail and ensuring the natural flow state of the natural river channel, specifically, the regulation process is based on the upstream hydroelectric dam simulating natural river flow state and the downstream hydroelectric dam controlling the realization of the goal that discharging water of the natural river channel at the reservoir tail, the discharge flow of the upstream hydroelectric dam and the downstream hydroelectric dam is obtained by the following methods:

(1) A calculation method of the discharge flow of the upstream hydroelectric dam:

The increasing flow and flow rate from March to May are important external conditions which stimulate fish breeding. Regulating the discharge flow of the upstream reservoir, the purpose is to make the water depth and flow rate of the fish breeding and spawning reach meet external flow field conditions which stimulate the fish breeding and spawning.

Taking the dekad water inflow process at the breeding and spawning reach from March to May during dry years (P=90%), as the minimum water requirement for the reach to ensure the normal breeding and spawning of fishes; that is the minimum target value of upstream reservoir ecological regulation. Taking the dekad water inflow process from March to May during wet years (P=10%) as the maximum water requirement for the reach to ensure the normal breeding and spawning of fishes; that is the maximum target value of upstream reservoir ecological regulation.

For example, in the dry years (P=90%) fish spawning period (from March to May), the calculation method is as follows:

Collecting measured daily flow data from March to March at the fish spawning reach (upstream, downstream or adjacent basin), the data sequence length (n) must be greater than 30 years; and analyzing the reliability, representativeness and consistency of the data. Yearly counting the total water inflows Wᵢ (i=1, 2, . . . , n) from March to May, and calculating hydrologic frequency analysis of total water inflows Wᵢ from March to May by the Pearson III curve, taking years when P=90% as the dry years, and determining the total water inflows WS_{dry} from March to May in dry years. The calculation of the water inflows in the fish spawning ground is calculated according to formula (1).

$${WF}_{dry} = {WS}_{dry} \times \frac{AF}{A S} \times \frac{PF}{P S} \qquad ( 1 )$$

wherein,

WF_{dry} is a design water inflows from March to May during dry years in the fish spawning ground;

WS_{dry} is a design water inflows from March to May during dry years in reference hydrological station;

AF and AS are the basin areas (km²) above the fish spawning ground and above reference hydrological station respectively;

PF and PS are the average precipitation (mm) for many years of basins above the fish spawning ground and above reference hydrological station respectively.

Annual dekad flow process from March to May is counted; according to the principle that the total water inflows are similar and are conducive to breeding and spawning of fishes, a typical process (Q31, Q32, Q33, Q41, Q42, Q43, Q51, Q52, Q53) of dekad distribution of water inflows from March to March is selected from the data sequence. According to the typical process and the determined total water inflows WF_{dry} from March to May, the water inflows process (q_{dry31}, q_{dry32}, q_{dry33}, q_{dry41}, q_{dry42}, q_{dry43}, q_{dry51}, q_{dry52}, q_{dry53}) under the design guarantee rate (P=90%) is obtained by formula (2), as the lowest target process of upstream reservoir ecological regulation.

q_{dryij}=WF_{dry}·Qᵢⱼ/Σₖ₌₃⁵Σₗ₌₁³Qₖₗ (2)

Wherein:

q_{dryij} is the lowest target ecological regulation flow of upstream reservoir in the jth ten days of the i month;

WF_{dry} is the water flows when the design guarantee rate of fish spawning reach P=90%;

the dekad water inflow process q_{wetij} from March to May during wet years (P=10%) can be determined in the same way.

An ecological regulation flow QEᵢⱼ of upstream reservoir in the jth ten days of the i month is determined by formula (3), there is no need to increase the ecological regulation flow when power generation flow QP^{ij} of the upstream reservoir is greater than or equal to the target ecological regulation flow q_{dryij}, and less than or equal to q_{wetij}; it is necessary to increase the ecological regulation flow through the reservoir ecological regulation when the power generation flow QP^{ij} of the upstream reservoir is less than the target ecological regulation flow q_{dryij}.

During the ecological regulation period of the reservoir from March to May, the ten-days average discharge flow of the reservoir should not exceed the flow of the same period in wet years;

$$Q {E}_{ij} = \{ \begin{matrix}0 , {q}_{wetij} \geq Q {P}_{ij} \geq {q}_{dryij} \\ {q}_{ij} - Q {P}_{ij} , {QP}_{ij} < {q}_{ij}\end{matrix} \qquad ( 3 )$$

Wherein:

QEᵢⱼ is the ecological regulation flow (m³/s) of upstream reservoir in the jth ten days of the i month;

QPᵢⱼ is the power generation flow (m³/s) of the upstream reservoir in the jth ten days of the i month;

other symbols have the same meaning as before.

(2) A calculation method of the discharge flow of the downstream hydroelectric dam:

The discharge flow of the downstream hydroelectric dam is regulated according to the water level, that is, during the breeding and spawning period of native fishes from March to May, a water level 4 in the hydrostatic reservoir area of the downstream dam is regulated to not higher than the water level elevation at the end of the reservoir tail reach.

### Embodiments

### 1. Project Profile

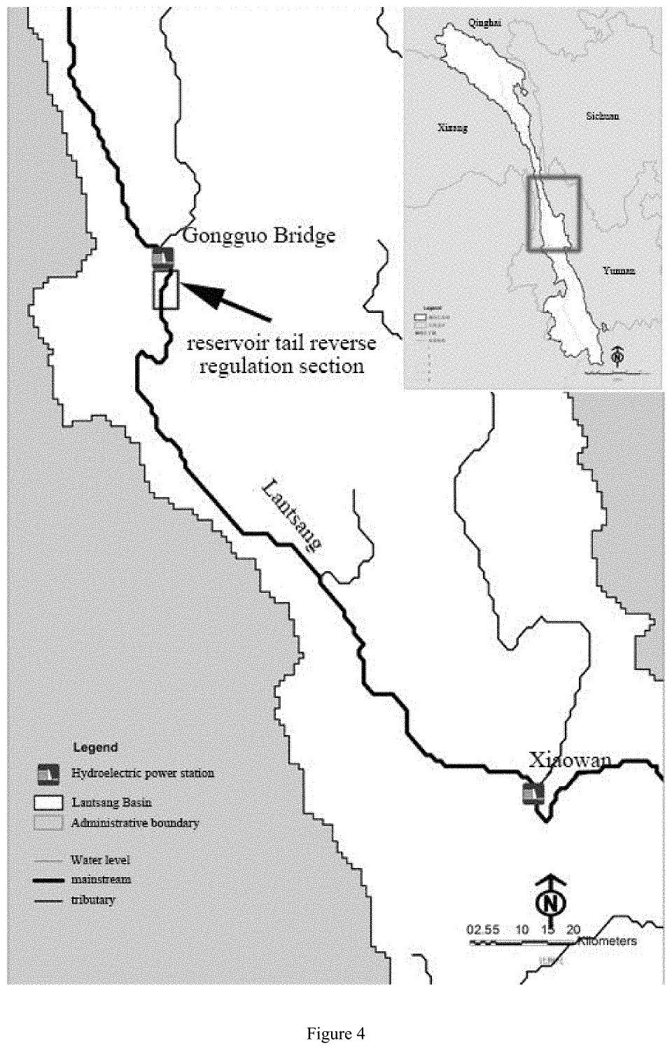

As shown in FIG. 4, as one of the thirteen largest hydropower energy bases in China, the Lancang River basin is rich in water resources, mainstream thereof is planned to develop 15 cascade hydropower stations with a total installed capacity of more than 26 million kilowatts. Among the developed power stations in the middle and lower reaches, the Xiaowan hydropower station is the “leading reservoir”, the power station is located in the middle reaches of the Lancang River at the junction of Nanjiang County, Dali Prefecture, Yunnan Province and Fengqing County, Lincang City. The upstream is Gongguoqiao hydropower station and the downstream is Manwan hydropower station. The total storage capacity of the power station is about 15 billion cubic meters, and the regulation storage capacity is nearly 10 billion cubic meters with years of regulation capability; the installed capacity of the power station is 4.2 million kilowatts, the elevation of the dam crest is 1,245 meters, the lowest base elevation is 953 meters, the maximum dam height is 292 meters, the dam crest is 992.74 meters long, the crown cantilever bottom width is 69.49 meters, and the crown cantilever top width is 13 meters. The dam is provided with 5 surface hole spillways, 6 mid-discharge orifices and 2 vent holes. The total discharge of the pivot is 17680 cubic meters per second when designing the flood level and 20680 cubic meters per second when the flood level is checked (wherein surface holes discharge at 8625 cubic meters per second, the middle holes discharge at 6730 cubic meters per second, and flood releasing tunnel at left bank discharges at 5325 cubic meters per second), backwaters of the mainstream is 198 kilometers long, which is put into operation in August, 2010.

The Xiaowan hydropower station is developed by a way of cascade hydropower, and the operation of the power station causes the backwaters of the reservoir reach the upstream dam of the Gongguoqiao hydropower station. In order to protect the precious native fish germplasm resources in the Lancang River and maintain the river ecological health, Lancang River Hydropower Inc. and Yunnan University jointly carried out researches on the reservoir tail reverse regulation measures for migration native fish protection.

### 2. Reservoir Tail Reverse Regulation Technical Method

\textcircled{1} Based on field investigations and inspections of the Xiaowan Hydropower Station Environmental Impact Assessment and Yunnan Fish Records, it is determined that the native fishes that need to be protected in the Xiaowan reservoir area mainly include fishes that can adapt to live in torrent such as schizothorax lissolabiatus, gray schizothoracin and percocypris pingi retrodorslis. The breeding period of indigenous fish is concentrated from March to May, the essential condition required for breeding is liquid water, the optimum water temperature is 14-18° C., and the dissolved oxygen content is not less than 8.0 mg/L. \textcircled{2} Through the investigation of the reservoir tail reach of the Xiaowan hydropower station in this period, and the reservoir tail reach of 36 km from the Gongguoqiao hydropower station to the Xiaowan hydropower station was identified; from March to May, the hydrological regime such as fluvial morphology, landform, river flow, water level, flow rate, sediment charge and sediment quality, have natural river characteristics, which are met the conditions for the establishment of native fish breeding habitats. \textcircled{3} According to the calculations of cascade hydropower storage capacity, water level and discharge flow of Xiaowan and Gongguoqiao cascade hydropower stations, and under the premise of meeting the constraints of flood control and power generation, the discharge flow of Xiaowan hydropower station was regulated, the discharge flow is increased to ensure the 36 km of reservoir tail reverse regulation reach maintain the natural fluvial morphology from March to May; simultaneously, controlling the discharge flow of the upstream Gongguoqiao hydropower station, regulating river channels in Pojiao village which located at reverse regulation reach, creating a suitable fish spawning ground, and in Tangjian county, carrying out artificial propagation and releasing measure of native fish filial generation.

Based on the native fish protection in mountainous areas and the timing of ecological restoration of the reservoir tail reach in the channel type reservoir during dry seasons, and using the joint regulation capability of the cascade reservoir, to manually control the discharge process of the adjacent two upstream and downstream dams during the breeding and spawning period of native fishes, accompanying with ecological rehabilitation project, the river ecosystem in hydro-fluctuation belt reach of reservoir tail will restore the natural form (restore the natural flow states of torrent, dangerous shoals and backwaters) as much as possible, and restoring the habitat suitable for the breeding characteristics of native fishes, thereby the purpose of preserving native fish germplasm resources and the technology of ecological regulation of hydropower stations can be achieved.

According to the joint regulation capability of the cascade reservoir, the landform, hydroelectricity and hydropower regime in the downstream reach of cascade hydroelectric dam, and environmental conditions required for breeding characteristics of the migration native fishes, under the conditions of no need to demolish dams and basically no effect on the power generation efficiency of power stations, by using favorable conditions of that the high dam large reservoir increases the regulation of power generation and the antiaircraft and flood-control storage capacity before flood season and during dry years, by optimized ecological regulation of upstream and downstream hydropower stations at the reach to meet the habitat requirements of fish breeding, pointedly putting forward reservoir tail reverse regulation technology, thereby, the purpose of preserving native fish germplasm resources can be achieved, and integrated and coordinated development of economic benefits, environmental benefits and social benefits can be realized.

The embodiments in the disclosure are described in a related way, and the same or similar parts in the embodiments should be referred to each other, and each emphatic part in single embodiment is in differences from other embodiments. In particular, for system embodiments, the description is relatively simple for it is basically similar to the method embodiment, thereby, the relevant parts should be referred to the description of method embodiments.

The above is merely the preferred embodiment of the invention and is not intended to limit the scope of the invention. Any modifications, equivalent substitutions, improvements, etc. made within the spirit and scope of the invention should be included in the scope of the invention.

1. A reservoir tail reverse regulation method for native fish protection, comprising following steps:
Step 1, a breeding habitat of native fishes at the reservoir tail of a cascade hydroelectric dam is determined;
Step 2, breeding characteristics of the migration native fishes are determined, and an ecological conservation project of a reach of the breeding habitat at the reservoir tail is carried out;
Step 3, reservoir tail reverse regulation method of the cascade hydroelectric dam, the length of the reservoir tail of a downstream hydropower station of a cascade hydroelectric project in March to May is determined through a field investigation, and the maximum range of a natural river channel downstream of an upstream cascade power station is judged, that is reverse regulation reach; in order to ensure the reservoir tail of the power station, that is, the hydrological regime at breeding habitat reach of native fishes meets the requirements for fish breeding and spawning, an elevation measurement of reservoir area river bed, calculations of cascade hydropower storage capacity, water level and discharge flow are carried out; according to the calculation results, the discharge flow of an upstream hydroelectric dam and a downstream hydroelectric dam are jointly scheduled, and finally a flow state of the reach at the reservoir tail is reversely regulated to achieve the goal of discharging water of the natural river channel at the reservoir tail and ensuring the natural flow state of the natural river channel.

2. The reservoir tail reverse regulation method for native fish protection of claim 1, wherein in Step 1, the breeding habitat of native fishes is disposed at a reach of the cascade hydroelectric project, between two hydropower stations and under upstream hydroelectric dam, that is, reservoir tail of the downstream hydroelectric dam; from March to May, the field investigation of reservoir tail area and data collection of hydrological regime are carried out, combined with fluvial morphology, landform, river flow, water level, flow rate, sediment charge and sediment quality, a reach which is distinct from the water characteristics of the lake and has natural river characteristics is further selected as a reverse regulation reach.

3. The reservoir tail reverse regulation method for native fish protection of claim 1, wherein the Step 2 comprises, through field investigation and data analysis, identifying species of to-be-protected native fishes and seeking surviving and breeding characteristics thereof including population quantity and structure, spawning time and water temperature, flow rate, water transparency, and sediment charge required by the breeding ground; according to the breeding characteristics of native fishes, the artificial fish breeding ecological restoration measures are arranged in the native fish breeding habitat determined in Step 1, including artificially excavating shallow channel and deep pool of the river, constructing shore protection and slope vegetation, arranging fish nest and river branch remediation and carrying out artificial propagation and releasing of important native fishes in the habitat.

4. The reservoir tail reverse regulation method for native fish protection of claim 1, wherein in Step 3, the regulation process is based on the upstream hydroelectric dam simulating natural river flow state and the downstream hydroelectric dam controlling the realization of the goal that discharging water of the natural river channel at the reservoir tail, the discharge flow of the upstream hydroelectric dam and the downstream hydroelectric dam is obtained by the following methods:
(1) A calculation method of the discharge flow of the upstream hydroelectric dam:
Taking the dekad water inflow process at the breeding and spawning reach from March to May during dry years, as the minimum water requirement for the reach to ensure the normal breeding and spawning of fishes; taking the dekad water inflow process from March to May during wet years as the maximum water requirement for the reach to ensure the normal breeding and spawning of fishes;
Wherein the dekad water inflow process from March to May during dry years is obtained by the following method: collecting measured daily flow data from March to March at the fish spawning reach, the data sequence length n must be greater than 30 years; yearly counting the total water inflows Wᵢ (i=1,2, . . . ,n) from March to May, and calculating hydrologic frequency analysis of total water inflows W, from March to May by the Pearson III curve; the probability density function is:
$$f ( x ) = \frac{{β}^{α}}{Γ ( α )} {( x - {α}_{0} )}^{α - 1} {e}^{- β ( x - {α}_{0} )}$$
Wherein, Γ(α) is the gamma function of α; α, β and α₀ are respectively the shape, scale and positional parameters of the Pearson III distribution, α>0, β>0, taking the corresponding water inflows WS_{dry} when the water inflows guarantee rate P=90%; for the water inflows of basin section is directly proportional to the basin area and average precipitation thereof, the calculation of water inflows from the fish spawning ground is calculated according to formula (1);
$${WF}_{dry} = {WS}_{dry} \times \frac{AF}{A S} \times \frac{PF}{P S} \qquad ( 1 )$$
wherein,
WF_{dry} is a design water inflows from March to May during dry years in the fish spawning ground;
WF_{dry} is a design water inflows from March to May during dry years in reference hydrological station;
AF and AS are basin areas above the fish spawning ground and above reference hydrological station respectively;
PF and PS are annual mean precipitation of basins above the fish spawning ground and above reference hydrological station respectively;
according to the measured daily flow data, annual dekad flow process from March to May is counted; according to the principle that the total water inflows are similar and are conducive to breeding and spawning of fishes, a typical process of dekad distribution of water inflows from March to March is selected from the data sequence, according to the typical process and the determined total water inflows WF_{dry} from March to May, the water inflows process under the design guarantee rate P=90% is obtained by formula (2), as the lowest target process of upstream reservoir ecological regulation;
q_{dryij}=WF_{dry}·Qᵢⱼ/Σₖ₌₃⁵Σₗ₌₁³Qₖₗ (2)
Wherein, q_{dryij} is the lowest target ecological regulation flow of upstream reservoir in the jth ten days of the i month; WF_{dry} is the water flows when the design guarantee rate of fish spawning reach P=90%;
the dekad water inflow process q_{wetij} from March to May during wet years can be determined in the same way;
an ecological regulation flow QEᵢⱼ, of upstream reservoir in the jth ten days of the i month is determined by formula (3), there is no need to increase the ecological regulation flow when power generation flow QPᵢⱼ of the upstream reservoir is greater than or equal to the target ecological regulation flow q_{dryij}, and less than or equal to q_{wetij}; it is necessary to increase the ecological regulation flow through the reservoir ecological regulation when the power generation flow QPᵢⱼ of the upstream reservoir is less than the target ecological regulation flow q_{dryij};
during the ecological adjustment period of the reservoir from March to May, the ten-days average discharge flow of the reservoir should not exceed the flow of the same period in wet years;
$$Q {E}_{ij} = \{ \begin{matrix}0 , {q}_{wetij} \geq Q {P}_{ij} \geq {q}_{dryij} \\ {q}_{ij} - Q {P}_{ij} , {QP}_{ij} < {q}_{ij}\end{matrix} \qquad ( 3 )$$
wherein, QEᵢⱼ is the ecological regulation flow of upstream reservoir in the jth ten days of the i month; QPᵢⱼ is the power generation flow of the upstream reservoir in the jth ten days of the i month;
(2) A calculation method of the discharge flow of the downstream hydroelectric dam:
The discharge flow of the downstream hydroelectric dam is regulated according to the water level, that is, during the breeding and spawning period of native fishes from March to May, a water level in the hydrostatic reservoir area of the downstream dam is regulated to not higher than the water level elevation at the end of the reservoir tail reach.
